(19) United States
(12) Patent Application Publication
(10) Pub. No.: US 2008/0252572 A1
(43) Pub. Date: Oct. 16, 2008

(54) Organic electroluminescent display and image correction method thereof

(76) Inventors: Kinyeng Kang, Yongin-si (KR); Hyeonggwon Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/071,973

(22) Filed: Feb. 28, 2008

(30) Foreign Application Priority Data
Apr. 10, 2007 (KR) 10-2007-0034969

(51) Int. Cl. G09G 3/30

(52) U.S. Cl. 345/77

(57) ABSTRACT

An organic electroluminescent display includes an image signal processor configured to receive an analog image signal from an external source and to convert the analog image signal to a digital image signal, a brightness sensor configured to measure brightness of an external light and to convert the measured brightness into a brightness signal, a wavelength sensor configured to measure wavelength of the external light and to convert the measured wavelength into a wavelength signal, a data controller configured to receive the digital image signal, the brightness signal, and the wavelength signal, and to generate a corrected image signal, a data driver coupled electrically to the data controller, and a display panel configured to receive the corrected image signal from the data controller via the data driver and to display an image.

### BACKGROUND OF THE INVENTION

1. Field of the Invention

Embodiments of the present invention relate to an organic electroluminescent (EL) display and an image correction method thereof. More particularly, embodiments of the present invention relate to an organic EL display and an image correction method capable of controlling brightness and color display thereof with respect to external light.

2. Description of the Related Art

Generally, an electroluminescent (EL) display refers to a display device displaying images by electrically exciting photoluminescent materials coated on a substrate or on a film to emit light. The electrical excitement may be generated by applying voltage via electrodes to the photoluminescent material, e.g., organic light emitting layer. Such EL displays may be used, e.g., in portable information devices, because of their lightweight, thin display, excellent color brightness, and large viewing angles.

The conventional EL display, e.g., an active EL display, may include a plurality of pixels with light emitting elements. More specifically, each pixel of the plurality of pixels may include three sub-pixels, i.e., red (R), green (G), and blue (B), and each sub-pixel may include a light emitting layer between an anode electrode and a cathode electrode. Application of voltage to the anode and cathode electrodes may generate light emission from a light emitting layer of a corresponding R, G, or B sub-pixel.

The amount of light emitted from a conventional light emitting layer, i.e., brightness, may be set to a predetermined value regardless of brightness of external lights. For example, the conventional EL display may be designed to have an optimum brightness value indoors, i.e., a relatively large amount of emitted light, when brightness of external lights may be relatively low. However, such a set optimum brightness value may be too high in dark places, and may be too low in bright places, thereby reducing visibility. Further, the set predetermined brightness value, e.g., optimum brightness indoors, may increase power consumption, e.g., when brightness of external lights is relatively low. In addition, the set predetermined brightness value may establish predetermined light intensity of red, green, and blue-lights of the R, G, B sub-pixels, regardless of the external light, thereby distorting color display, e.g., exhibiting blue images under a fluorescent lamp and red images under an incandescent lamp.

### SUMMARY OF THE INVENTION

Embodiments of the present invention are therefore directed to an organic electroluminescent (EL) display and an image correction method thereof, which substantially overcome one or more of the disadvantages of the related art

It is therefore a feature of an embodiment of the present invention to provide an organic EL display capable of automatically adjusting brightness display thereof with respect to brightness of external light.

It is another feature of an embodiment of the present invention to provide an organic EL display capable of automatically adjusting color display thereof with respect to wavelength of external light.

It is yet another feature of an embodiment of the present invention to provide a method of adjusting an image displayed by an organic EL display having one or more of the above features.

At least one of the above and other features and advantages of the present invention may be realized by providing an organic EL display, including an image signal processor configured to receive an analog image signal from an external source and to convert the analog image signal to a digital image signal, a brightness sensor configured to measure brightness of an external light and to convert the measured brightness into a brightness signal, a wavelength sensor configured to measure wavelength of the external light and to convert the measured wavelength into a wavelength signal, a data controller coupled electrically to the image signal processor, the brightness sensor, and the wavelength sensor, the data controller being configured to receive the digital image signal, the brightness signal, and the wavelength signal, and to generate a corrected image signal, a data driver coupled electrically to the data controller, and a display panel coupled electrically to the data driver, the display panel being configured to receive the corrected image signal from the data controller via the data driver and to display an image.

The data controller may be configured to output a corrected image signal for each digital image signal with respect to the wavelength signal. The external light may have a wavelength in a range of about 400 nm to about 700 nm. The data controller may include a brightness look-up table including a plurality of brightness correction parameters with respect to brightness of the external light, a wavelength look-up table including a plurality of wavelength correction parameters with respect to wavelength of the external light, and a data corrector configured to apply a brightness correction parameter of the plurality of brightness correction parameters and a wavelength correction parameter of the plurality of wavelength correction parameters to the digital image signal to generate a correction digital image signal. The plurality of brightness correction parameters in the brightness look-up table may be in direct proportion to changes in brightness of the external light. The plurality of wavelength correction parameters in the wavelength look-up table may include a plurality of red color correction parameters and a plurality of blue color correction parameters, the blue correction parameters varying in a same direction as changes in wavelength of the external light, and the red correction parameters being inversely related to the blue correction parameters.

The corrected image signal received by the display panel may increase brightness of the display panel when brightness of the external light increases. The corrected image signal received by the display panel may decrease brightness of the display panel when brightness of the external light decreases. The corrected image signal received by the display panel may increase luminance of red color pixels of the display panel and decrease luminance of blue color pixels of the display panel when wavelength of the external light decreases. The corrected image signal received by the display panel may decrease luminance of red color pixels of the display panel and increase luminance of blue color pixels of the display panel wavelength of the external light increases.

At least one of the above and other features and advantages of the present invention may be further realized by providing a method of correcting an image of an organic EL display, including converting measured brightness of an external light to a brightness signal, converting measured wavelength of the external light to a wavelength signal, obtaining correction data, the correction data proportionately related to the brightness and wavelength signals, applying the correction data to a received image signal to automatically form a corrected image signal, and outputting the corrected image signal to display an image.

Applying the correction data may include applying the brightness signal to the image signal to form a first image signal and applying the wavelength signal to the first image signal to form a second image signal, the second image signal being the corrected image signal. Applying the correction data may include applying the wavelength signal to the image signal to form a first image signal and applying the brightness signal to the first image signal to form a second image signal, the second image signal being the corrected image signal. Applying the correction data may include applying the brightness and wavelength signals simultaneously to the image signal to form the corrected image signal. Obtaining the correction data may include using a brightness look-up table, the brightness look-up table including brightness correction parameters directly proportionate to brightness changes of the external light. Outputting the corrected image signal may include increasing light emitted from pixels of the organic EL display with respect to an increase of the measured brightness signal and decreasing light emitted from the pixels of the organic EL display with respect to a decrease of the measured brightness signal. Obtaining the correction data may include using a wavelength look-up table with red and blue correction parameters, the blue correction parameters being varying in a same direction as wavelength changes of the external light, and the red correction parameters being inversely related to the blue correction parameters. Converting measured wavelength of the external light may include measuring the wavelength of the external light in a range of about 400 nm to about 700 nm. Outputting the corrected image signal may include increasing light emitted from red sub-pixels of the organic EL display and decreasing light emitted from blue sub-pixels of the organic EL display with respect to a decrease of the measured wavelength signal. Outputting the corrected image signal may include decreasing light emitted from red sub-pixels of the organic EL display and increasing light emitted from blue sub-pixels of the organic EL display with respect to an increase of the measured wavelength signal.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic block diagram of an organic EL display according to an exemplary embodiment of the present invention;

FIGS. 2A-2B illustrate circuit and timing diagrams, respectively, of an exemplary pixel circuit of the organic EL display of FIG. 1;

FIGS. 3-4 illustrate graphs of brightness and color, respectively, of the organic EL display of FIG. 1 with respect to external light;

FIG. 5A illustrates a flow chart of an image correction method for an organic EL display according to an exemplary embodiment of the present invention;

FIG. 5B illustrates a flow chart of an image correction method for an organic EL display according to another exemplary embodiment of the present invention; and

FIGS. 6A-6B illustrate detailed flow charts of FIGS. 5A-5B, respectively.

### DETAILED DESCRIPTION OF THE INVENTION

Korean Patent Application No. 10-2007-0034969, filed on Apr. 10, 2007, in the Korean Intellectual Property Office, and entitled: “Organic Electro Luminescence Display and Image Correction Method Thereof,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when a layer or element is referred to as being “on” another layer, element, or substrate, it can be directly on the other layer, element, or substrate, or intervening layers or elements may also be present. Further, it will also be understood that when a layer or element is referred to as being “between” two layers or elements, it can be the only layer or element between the two layers or elements, or one or more intervening layers or elements may also be present. In addition, it will be understood that when a layer or element is “electrically coupled” to another element, they may be coupled directly to one another or additional elements may be present there between.

Hereinafter, “brightness” of light refers to an overall amount of light, i.e., a photometric quantity of luminance measured in candela per unit area (cd/m²=1 nit), emitted from a light source, i.e., an external light and/or an EL display. For example, brightness of light emitted from an EL display may refer to luminance of all pixels of the EL display.

“External light” refers, hereinafter, to an ambient light surrounding an EL display. Examples of ambient light may include one or more of sunlight, e.g., visible light in a range of about 400 nm to about 700 nm, light emitted by an incandescent lamp, i.e., infrared light, a weak yellow light or a weak orange light, and/or light emitted by a fluorescent lamp, i.e., ultraviolet light, a weak blue light or a weak green light. For example, when the external light includes mostly short wavelengths, a fluorescent lamp may be assumed as the external light. Similarly, when the external light includes mostly long wavelengths, an incandescent lamp may be assumed as the external light. When the external light includes both long and short wavelengths, e.g., a substantially similar distribution, sunlight may be assumed as the external light.

It is further noted that “wavelength” of light refers to a type of electromagnetic radiation emitted from the light source, i.e., an external light and/or an EL display. For example, wavelength of light emitted from an EL display may refer to luminance of individual sub-pixels, e.g., red and/or blue. Accordingly adjustment of “wavelength” and “color” as displayed or exhibited by an EL display may be used interchangeably.

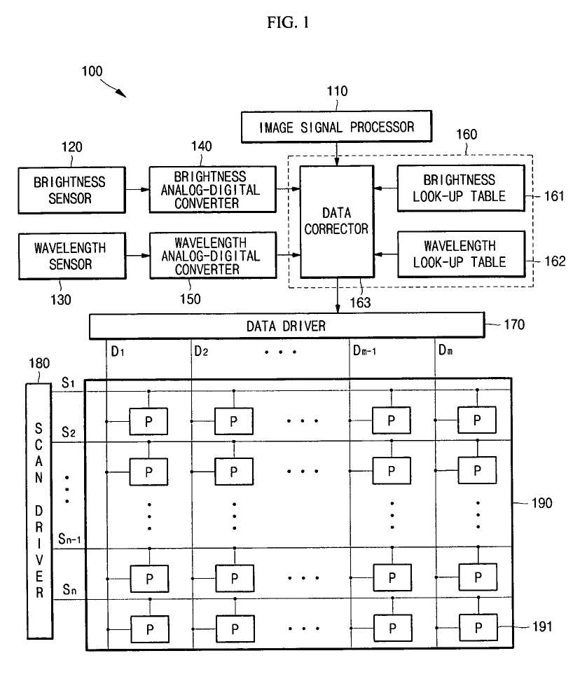

FIG. 1 illustrates a schematic block diagram of an organic EL display according to an exemplary embodiment of the present invention.

Referring to FIG. 1, an organic EL display 100 may include an image signal processor 110, a brightness sensor 120, a wavelength sensor 130, a brightness analog-digital converter 140, a wavelength analog-digital converter 150, a data controller 160, a data driver 170, a scan driver 180, and a display panel 190.

The image signal processor 110 of the organic EL display 100 may receive an analog image signal from an external device, and may convert the analog image signal to a digital image signal. The digital image signal may include separate components of red, green, and/or blue colors.

The brightness sensor 120 of the organic EL display 100 may sense brightness of an external light, and may output an electrical signal corresponding to the sensed brightness of the external light. The electrical signal output by the brightness sensor 120 may be a current signal or a voltage signal.

The wavelength sensor 130 of the organic EL display 100 may sense wavelength of the external light, and may output an electrical signal corresponding to the sensed wavelength of the external light. The electrical signal output by the wavelength sensor 130 may be a current signal or a voltage signal. A range of the sensed wavelength may be adjusted to any suitable range. For example, the wavelength range may be about 400 nm to about 700 nm. In this respect, it is noted that a wavelength of about 400 nm may correspond to a blue color light measured under a fluorescent lamp, and a wavelength of about 700 nm may correspond to a red color light measured under an incandescent lamp. Further, all wavelengths between about 400 nm to about 700 nm may be measured under sunlight.

The brightness analog-digital converter 140 of the organic EL display 100 may be electrically coupled between the brightness sensor 120 and the data controller 160. The brightness analog-digital converter 140 may receive the electrical signal output by the brightness sensor 120, and may convert the electrical signal into a digital brightness signal.

The wavelength analog-digital converter 150 of the organic EL display 100 may be electrically coupled between the wavelength sensor 130 and the data controller 160. The wavelength analog-digital converter 150 may receive the electrical signal output by the wavelength sensor 130, and may convert the electrical signal into a digital wavelength signal.

The data controller 160 of the organic EL display 100 may receive the digital image signal from the image signal processor 110, the digital brightness signal from the brightness analog-digital converter 140, and the digital wavelength signal from the wavelength analog-digital converter 150. The data controller 160 may calculate a correction digital image signal with respect to the received digital brightness and wavelength signals, and may transmit the correction digital image signal to the data driver 170. The data controller 160 may include a brightness look-up table 161, a wavelength look-up table 162, and a data corrector 163 to adjust the digital image signal received from the image signal processor 110 with respect to the digital brightness and wavelength signals received from the brightness and wavelength analog-digital converters 140 and 150.

The brightness look-up table 161 of the data controller 160 may include a plurality of brightness correction parameters corresponding to a plurality of external brightness ratio values. More specifically, a change in external brightness, i.e., an external brightness ratio value, may have a proportionately related brightness correction parameter in the brightness look-up table 161. The corresponding brightness correction parameter may include a luminance value directly proportionate to the change in the external brightness, so the luminance value may be used to adjust an overall luminance of an image signal with respect to the change in the external brightness. For example, when the external brightness is increased, a corresponding brightness correction parameter, i.e., a luminance value proportionately increased with respect to the increase in the external brightness, may be obtained in the look-up table 161 in order to adjust the image signal with respect to the increase in the external brightness. Similarly, when the external brightness is decreased, a corresponding brightness correction parameter, i.e., a luminance value proportionately decreased with respect to the decrease in the external brightness, may be obtained in the look-up table 161 in order to adjust the image signal with respect to the decrease in the external brightness.

The wavelength look-up table 162 of the data controller 160 may include a plurality of wavelength correction parameters corresponding to a plurality of external wavelength ratio values. More specifically, a change in external wavelength, i.e., an external wavelength ratio value, may have two proportionately related correction parameters in the wavelength look-up table 162. In particular, the corresponding wavelength correction parameters may include red and blue luminance values proportionately related to the change in the external wavelength, so the red and blue luminance values may be used to adjust an image signal with respect to the change in the external wavelength. For example, when the external wavelength is increased, two corresponding wavelength correction parameters, i.e., a red luminance value proportionately decreased with respect to the increase in the external wavelength and a blue luminance value proportionately increased with respect to the increase in the external wavelength, may be obtained in the wavelength look-up table 162 in order to adjust the image signal with respect to the increase in the external wavelength. Similarly, when the external wavelength is decreased, two corresponding wavelength correction parameters, i.e., a red luminance value proportionately increased with respect to the decrease in the external wavelength and a blue luminance value proportionately decreased with respect to the decrease in the external wavelength, may be obtained in the wavelength look-up table 162 in order to adjust the image signal with respect to the decrease in the external wavelength.

The data corrector 163 of the data controller 160 may obtain brightness and wavelength correction parameters from the brightness look-up table 161 and wavelength look-up table 162, respectively, and may apply the obtained brightness and wavelength correction parameters to the digital image signal received from the image signal processor 110. For example, the data corrector 163 may adjust the digital image signal received from the image signal processor 110 with respect to brightness and wavelength of the external light by applying the brightness and wavelength correction parameters, respectively, thereby forming a correction digital image signal. The correction digital image signal may be output to the data driver 170.

The data driver 170 of the organic EL display 100 may be electrically coupled between the data controller 160 and the display panel 190. More specifically, the data driver 170 may receive the correction digital image signal from the data controller 160, and may output corresponding data signals, e.g., data voltages via m data lines (D1,D2, . . . , Dm), to the display panel 190 in order to adjust brightness and color display thereof. The data signals of the data driver 170 may include, e.g., brightness data voltage signals and/or wavelength data voltage signals, as determined by the correction digital image signal data. Accordingly, brightness and color of an image, i.e., at time of display by the display panel 190, may be adjusted simultaneously.

For example, when the brightness sensor 120 senses a relatively high brightness of the external light, the driver 170 may output a corresponding brightness data voltage, so all the red, green, and blue color pixels may emit an increased amount of light to increase an overall brightness of the display panel 190. Similarly, when the brightness sensor 120 senses a relatively low brightness of the external light, the data driver 170 may output a corresponding brightness data voltage, so all the red, green, and blue color pixels may emit a reduced amount of light to decrease the overall brightness of the display panel 190.

Simultaneously, wavelength of images display by the display panel 190 may be adjusted. For example, when the wavelength sensor 130 senses a short wavelength of the external light, e.g., about 400 nm, the data driver 170 may output a wavelength data voltage to increase red light luminance and decrease blue light luminance of the pixels. Similarly, when the wavelength sensor 130 senses a long wavelength of the external light, e.g., about 700 nm, the data driver 170 may output a wavelength data voltage to decrease red light luminance and increase blue light luminance in the pixels. As such, the color, i.e., wavelength, of light emitted from the pixels and displayed by the organic EL display 100 may be adjusted to exhibit natural colors with respect to the external light.

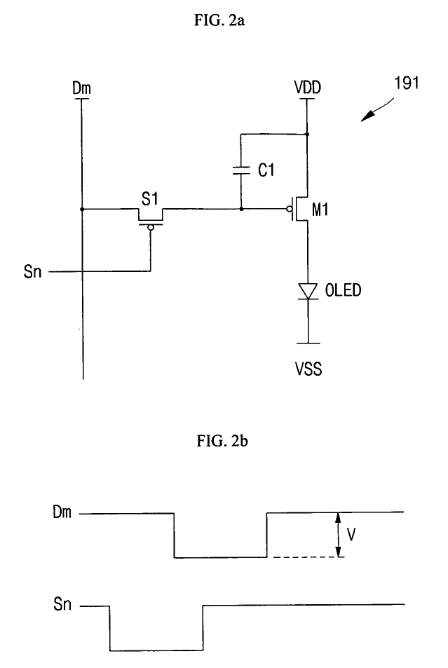

The scan driver 180 of the organic EL display 100 may be electrically coupled to the display panel 190, and may transmit selection signals to the display panel 190 via n scan lines (S1, S2, . . . , Sn). The display panel 190, i.e., a screen, may include a plurality of pixels P at intersections of the data lines and scan lines. Each pixel P of the plurality of pixels P may be electrically coupled to the data driver 170 via a respective data line (Dm) and to the scan driver 180 via a respective scan line (Sn). Each pixel P may include a pixel circuit to drive the pixel P. The pixel circuit may be any suitable driving circuit. For example, the pixel circuit may be a driving circuit 191, as will be discussed in more detail below with reference to FIGS. 2A-2B.

Referring to FIG. 2A, the pixel circuit 191 may include a scan line (Sn) for supplying a scan signal, a data line (Dm) for supplying a data signal, a first power source (VDD) for supplying a first voltage, a second power source (VSS) for supplying a second voltage, a switching transistor (S1), and a driving transistor (M1). Drain/source of the switching transistor (S1) may be coupled to the data line (Dm) and to a control electrode of the driving transistor (M1), and the scan line (Sn) may be coupled to the control electrode of the switching transistor (S1). Drain/source of the driving transistor (M1) may be coupled to the first and second power sources (VDD) and (VSS), and a diode OLED may be coupled between the transistor (M1) and the second power source (VSS). A capacitive element (C1) may be coupled between the first power line (VDD) and the control electrode of the driving transistor (M1). The first voltage may be higher than the second voltage. It is noted that the pixel circuit 191 is an exemplary embodiment of a pixel circuit only and other circuit configurations are within the scope of the present invention.

Referring to FIG. 2B, when a low-level control signal is supplied to the control electrode of the switching transistor S1 via the scan line (Sn), the switching transistor (S1) may be turned on, thereby enabling a data signal, e.g., data voltage V, transfer from the data line (Dm) to the driving transistor (M1), i.e., data writing operation. Transfer of data signal to the driving transistor (M1) may turn on the driving transistor (M1) to enable current flow from the first power source (VDD) to the second power source (VSS), thereby providing current to the diode OLED. The current flow through the diode OLED may correspond to the data signal supplied from the data line (Dm).

Accordingly, when brightness or wavelength of the external light changes, a corresponding data signal may be supplied via the data line (Dm) to the driving transistor (M1) and to the capacitive element (C1), thereby adjusting the current through the diode OLED. Adjustment of the current through the diode OLED may control the brightness of light emitted from the pixel P. As such, each pixel P may be adjusted to provide a predetermined brightness, so overall brightness and color of the display panel 190 may be adjusted with respect to the external light.

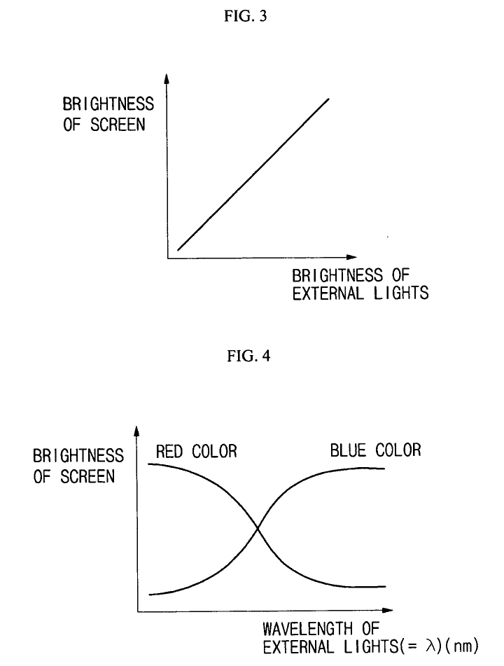

The brightness of light emitted from the display panel 190 may vary in direct proportion with respect to any changes in brightness of the external light, as graphically illustrated in FIG. 3. For example, the brightness correction parameters in the brightness look-up table 161 may vary brightness output by the display panel 190 by a substantially same luminance value as the change detected in the external light, so an overall brightness of the organic EL display 100 may be controlled automatically to improve display, e.g., in any bright or dark external light conditions. In this respect, it is noted that the x-axis in FIG. 3 represents brightness of external light measured by the brightness sensor 120, and the y-axis in FIG. 3 represents brightness as output by the display panel 190.

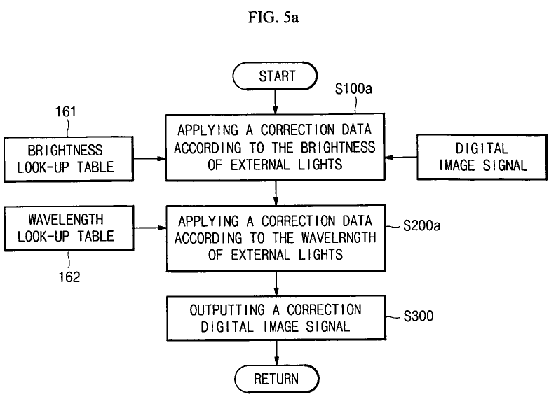

The color of red and blue pixels of the display panel 190 may be related proportionately to changes in the external light, as graphically illustrated in FIG. 4. For example, as illustrated in FIG. 4, blue wavelength correction parameters may be varied in a same direction as changes in the external wavelength, while red wavelength correction parameters may be inversely related to the blue wavelength correction parameters. In other words, the blue wavelength correction parameters may increase in value as the external wavelength increases, and may decrease in value as the external wavelength decreases. The red wavelength correction parameters may change value inversely, i.e., in an opposite direction, with respect to value changes of the blue wavelength correction parameters, so the red wavelength correction parameters may increase as the blue wavelength correction parameters decrease, and vice versa. For example, the wavelength correction parameters in the wavelength look-up table 162 may be used to increase red color intensity and decrease blue color intensity, when the wavelength of the external light decreases. Accordingly, an overall red and blue luminance of the organic EL display 100 may be controlled automatically to improve display in, e.g., bright or dark places, to exhibit more natural colors. In this respect, it is noted that the x-axis in FIG. 4 represents wavelength of external light measured by the wavelength sensor 130, and the y-axis in FIG. 4 represents brightness as output by the display panel 190.

Organic EL displays according to embodiments of the present invention may be advantageous in providing automatic control of the brightness and red/blue luminance thereof with respect to variance or changes in external light conditions in order to improve image display. For example, brightness and color of a displayed image in the organic EL display may be adjusted automatically in response to a change in conditions of the external light via the data controller, thereby eliminating need of manual adjustment, improving image display, and enhancing power efficiency.

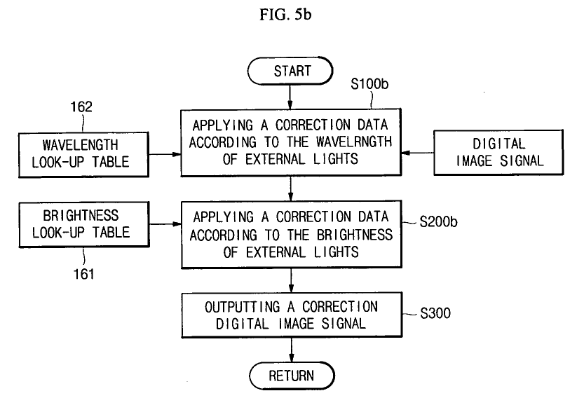

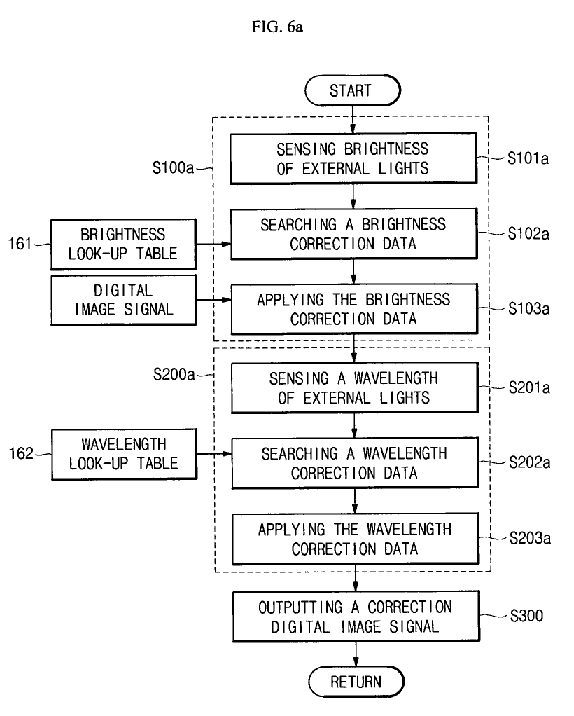

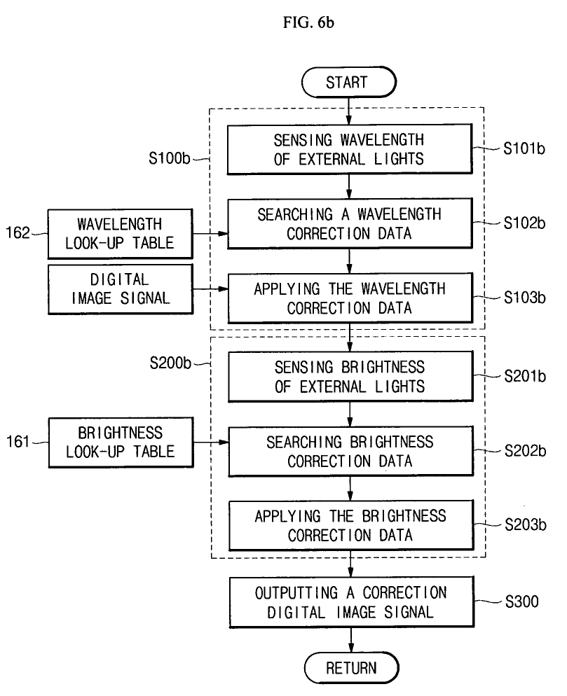

According to other embodiments of the present invention, a method of correcting display of an image in the display panel 190 with respect to brightness and/or wavelength of the external light will be described below with reference to FIGS. 5A-6B.

Referring to FIG. 5A, step S100a may include applying a brightness correction parameter to a digital image signal from the image signal processor 110 according to brightness of the external light. For example, the brightness analog-converter 140 may be used to determine brightness of the external light, so a corresponding brightness correction parameter from the brightness look-up table 161 may be applied to adjust brightness of the digital image signal from the image signal processor 110. Next, step S200a may include applying a wavelength correction parameter according to wavelength of the external light. For example, the wavelength analog-converter 150 may be used to determine wavelength of the external light, so a corresponding wavelength correction parameter from the wavelength look-up table 162 may be applied to adjust wavelength of the digital image signal from the image signal processor 110. Next, step S300 may include outputting the correction digital image signal. For example, applying the brightness and wavelength correction parameters to the digital image signal from the image signal processor 110, i.e., steps S100a and S200a, may modify brightness and wavelength of the digital image signal to from a correction digital image signal. The correction digital image signal may be output to the display panel 190 to display an image with improved color and brightness properties.

The method illustrated in FIG. 5A is illustrated in more detail in FIG. 6A. Referring to FIG. 6A, the image correction method may include sensing brightness of the external lights (S101a), searching brightness correction data in the brightness look-up table 161 with respect to the sensed brightness of the external lights (S102a), applying the brightness correction data to the digital image signal from the external device to form a first corrected image signal (S103a), sensing wavelength of external light (S201a), searching wavelength correction data in the wavelength look-up table 162 with respect to the sensed wavelength of the external light (S202a), applying the wavelength correction data to the first corrected image signal to form a second corrected image signal (S203a), and outputting the second corrected image signal as the correction digital image signal (S300).

More specifically, as illustrated in FIG. 6A, step S100a may include steps S101a, S102a, and S103a. For example, in step S101a, the brightness of the external light may be sensed and output as an electrical signal, e.g., a current signal or a voltage signal. Next, in step S102a, brightness correction data corresponding to the electrical signal output in step S101a may be obtained in the brightness look-up table 161. The brightness correction data may include correcting values to adjust brightness of the display panel 190 to correspond to the brightness of the external light as determined in step S101a. For example, a correcting value may increase brightness of the display panel 190 proportionately with respect to an increase in the brightness of the external light as determined in step S101a. Next, in step S103a, the brightness correction value obtained in step S102a may be applied to the digital image signal from the image signal processor 110 to adjust brightness of the digital image signal and to form a first corrected image.

As further illustrated in FIG. 6A, step S200a may include steps S201a, S202a and S203a. For example, in step S201a, the wavelength of the external light may be sensed and output as an electrical signal, e.g., a current signal or a voltage signal. The sensed wavelength range may be, e.g., from about 400 nm to about 700 nm. Next, in the step S202a, the wavelength correction data corresponding to the electrical signal output in step S201a may be obtained from the wavelength look-up table 162. The wavelength correction data may include correcting values to adjust luminance of the red and blue colors in the display panel 190 to correspond to the wavelength of the external light as determined in step S201a. For example, a correcting value may increase luminance of the red color and decrease luminance of the blue color with respect to a decrease in the wavelength of the external light as determined in step S201a. Next, in step S203a, the wavelength correction value obtained in step S202a may be applied to the first corrected image signal formed in step S103a to adjust red and blue luminance thereof and to form the second corrected image signal.

Next, as illustrated in FIG. 6A, the second corrected image is output as the correction digital image signal to the display panel 190. The output correction digital image signal may exhibit adjusted brightness and red/blue luminance values with respect to the external light as compared to the initial digital image received from the image processor 110. For example, when the brightness of the external light is relatively high, i.e., a relatively bright surrounding, the output correction digital image signal may increase an amount of light emitted from the organic EL display 100, so that an image displayed on the display panel 190 may be well seen in the relatively bright surrounding. On the other hand, when the brightness of the external light is relatively low, i.e. a relatively dark surrounding, the output correction digital image signal may decrease an amount of light emitted from the organic EL display 100, so that an image displayed on the display panel 190 may be well seen in the relatively dark surrounding.

Similarly, when the sensed wavelength of the external light is short, e.g., light provided by a fluorescent lamp having a wavelength of about 400 nm, the output correction digital image signal may increase luminance of the red color, while decreasing luminance of the blue color, in the organic EL display 100, so that an image displayed on the display panel 190 may exhibit natural colors as opposed to blue color series. On the other hand, when the sensed wavelength of the external light is long, e.g., light provided by an incandescent lamp having a wavelength of about 700 nm, the output correction digital image signal may decrease luminance of the red color, while increasing luminance of the blue color, in the organic EL display 100, so that an image displayed on the display panel 190 may exhibit natural colors as opposed to red series colors.

Accordingly, an image correction method according to embodiments of the present invention may be advantageous in providing automatic adjustment of brightness and color of a displayed image with respect to brightness and wavelength of the external light, so the organic EL display may have improved brightness and color display.

Alternatively, as illustrated in FIGS. 5B and 6B, the order of correction of the brightness and wavelength of the digital image signal may be reversed. For example, the digital image signal may be first corrected for color and then for brightness. As illustrated in FIG. 5B, in step S100a correction data may be applied according to wavelength of the external light, in step S200b correction data may be applied according to brightness of the external light, followed by step S300.

More specifically, as illustrated in FIG. 6B, step S100b may include steps S101b, S102b, and S103b that may be substantially similar to steps S201a, S202a, and S203a, respectively, described previously with reference to FIG. 6A. Step S200b may include steps S201b, S202b, and S203b that may be substantially similar to steps S101a, S102a, and S103a, respectively, described previously with reference to FIG. 6A. Accordingly, in step S103b, a wavelength correction value obtained in step S102b may be applied to the digital image signal from the image signal processor 110 to adjust red and blue luminance thereof and to form a first corrected image. A brightness correction value obtained in step S202b may be applied to the first corrected image signal formed in step S103b to adjust wavelength thereof and to form the second corrected image signal. Next, in step S300, the new correction digital image signal may be output with respect to the wavelength and brightness of the external light.

According to another alternative, brightness and wavelength of the digital image signal may be adjusted simultaneously. For example, brightness and wavelength correction parameters may be searched and determined in the brightness and wavelength look-up tables 161 and 162, simultaneous, so correction values may applied simultaneously to the digital image signal from the image signal processor 110 to form the new correction digital image signal.

As described above, embodiments of the organic EL display and image correction method according to the present invention may be advantageous in providing automatic adjustment of brightness of the organic EL display with respect to the brightness of external light, thereby improving display properties and power consumption efficiency. Further, the organic EL display and image correction method may provide automatic adjustment of colors exhibited by the organic EL display with respect to wavelength of external light, thereby improving display properties thereof.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic electroluminescent (EL) display, comprising:
an image signal processor configured to receive an analog image signal from an external source and to convert the analog image signal to a digital image signal;
a brightness sensor configured to measure brightness of an external light and to convert the measured brightness into a brightness signal;
a wavelength sensor configured to measure wavelength of the external light and to convert the measured wavelength into a wavelength signal;
a data controller coupled electrically to the image signal processor, the brightness sensor, and the wavelength sensor, the data controller being configured to receive the digital image signal, the brightness signal, and the wavelength signal, and to generate a corrected image signal;
a data driver coupled electrically to the data controller; and
a display panel coupled electrically to the data driver, the display panel being configured to receive the corrected image signal from the data controller via the data driver and to display an image.

2. The organic EL display as claimed in claim 1, wherein the data controller is configured to output a corrected image signal for each digital image signal with respect to the wavelength signal.

3. The organic EL display as claimed in claim 2, wherein the external light has a wavelength in a range of about 400 nm to about 700 nm.

4. The organic EL display as claimed in claim 1, wherein the data controller includes:
a brightness look-up table including a plurality of brightness correction parameters with respect to brightness of the external light;
a wavelength look-up table including a plurality of wavelength correction parameters with respect to wavelength of the external light; and
a data corrector configured to apply a brightness correction parameter of the plurality of brightness correction parameters and a wavelength correction parameter of the plurality of wavelength correction paramters to the digital image signal to generate a correction digital image signal.

5. The organic EL display as claimed in claim 4, wherein the plurality of brightness correction parameters in the brightness look-up table is in direct proportion to changes in brightness of the external light.

6. The organic EL display as claimed in claim 4, wherein the plurality of wavelength correction parameters in the wavelength look-up table includes a plurality of red color correction parameters and a plurality of blue color correction parameters, the blue color correction parameters varying in a same direction as changes in wavelength of the external light, and the red color correction parameters being inversely related to the blue correction parameters.

7. The organic EL display as claimed in claim 1, wherein the corrected image signal received by the display panel increases brightness of the display panel when brightness of the external light increases.

8. The organic EL display as claimed in claim 1, wherein the corrected image signal received by the display panel decreases brightness of the display panel when brightness of the external light decreases.

9. The organic EL display as claimed in claim 1, wherein the corrected image signal received by the display panel increases luminance of red color pixels of the display panel and decreases luminance of blue color pixels of the display panel when wavelength of the external light increases.

10. The organic EL display as claimed in claim 1, wherein the corrected image signal received by the display panel decreases luminance of red color pixels of the display panel and increases luminance of blue color pixels of the display panel when wavelength of the external light decreases.

11. A method of correcting an image of an organic electroluminescent (EL) display, comprising:
converting measured brightness of an external light to a brightness signal;
converting measured wavelength of the external light to a wavelength signal;
obtaining correction data, the correction data proportionately related to the brightness and wavelength signals;
applying the correction data to a received image signal to automatically form a corrected image signal; and
outputting the corrected image signal to display an image.

12. The method as claimed in claim 11, wherein applying the correction data includes applying the brightness signal to the image signal to form a first image signal and applying the wavelength signal to the first image signal to form a second image signal, the second image signal being the corrected image signal.

13. The method as claimed in claim 11, wherein applying the correction data includes applying the wavelength signal to the image signal to form a first image signal and applying the brightness signal to the first image signal to form a second image signal, the second image signal being the corrected image signal.

14. The method as claimed in claim 11, wherein applying the correction data includes applying the brightness and wavelength signals simultaneously to the image signal to form the corrected image signal.

15. The method as claimed in claim 11, wherein obtaining the correction data includes using a brightness look-up table, the brightness look-up table including brightness correction parameters directly proportionate to brightness changes of the external light.

16. The method as claimed in claim 15, wherein outputting the corrected image signal includes increasing light emitted from pixels of the organic EL display with respect to an increase of the measured brightness signal and decreasing light emitted from the pixels of the organic EL display with respect to a decrease of the measured brightness signal.

17. The method as claimed in claim 11, wherein obtaining the correction data includes using a wavelength look-up table with red and blue color correction parameters, the blue color correction parameters varying in a same direction as the wavelength changes of the external light, and the red color correction parameters being inversely related to the blue correction parameters.

18. The method as claimed in claim 17, wherein converting measured wavelength of the external light includes measuring the wavelength of the external light in a range of about 400 nm to about 700 nm.

19. The method as claimed in claim 17, wherein outputting the corrected image signal includes increasing light emitted from red sub-pixels of the organic EL display and decreasing light emitted from blue sub-pixels of the organic EL display with respect to a decrease of the measured wavelength signal.

20. The method as claimed in claim 17, wherein outputting the corrected image signal includes decreasing light emitted from red sub-pixels of the organic EL display and increasing light emitted from blue sub-pixels of the organic EL display with respect to an increase of the measured wavelength signal.
